(19) United States
(12) Patent Application Publication
(10) Pub. No.: US 2018/0022940 A1
(43) Pub. Date: Jan. 25, 2018

(54) BORATE PRODUCED BY WET GRINDING, AND USE THEREOF

(71) Applicant: Werner ZIMMERMANN, Mannheim (DE)

(72) Inventors: Werner ZIMMERMANN, Mannheim (DE); Albert TRIEM, Mannheim (DE); Joerg JODLAUK, Mannheim (DE)

(21) Appl. No.: 15/542,247

(22) PCT Filed: Jan. 7, 2016
(86) PCT No.: PCT/EP2016/050239

§ 371 Date: Jul. 7, 2017

(30) Foreign Application Priority Data
Jan. 8, 2015 (EP) 15150521.1

(51) Int. Cl. C09D 5/32; B27K 3/16; C09D 7/12; C09D 5/14; C01B 35/12

(52) U.S. Cl. CPC C09D 5/32; C09D 5/14; C01B 35/128; C09D 7/1275; B27K 3/163

(57) ABSTRACT

The invention relates to cation borate present in powder form, with a small grain size and low water solubility. The cation borate present in powder form and a suspension produced therefrom are suitable for example for the treatment of coating materials (such as wood preservatives), in particular fungicidal, biocidal and insecticidal treatment.

The present invention relates to cation borate present in powder form with a small grain size, low water solubility and preferably a high content of alkaline-earth borate, in particular calcium borate. The invention further relates to a process for producing the powder, a suspension that comprises this powder, the use of the powder or the suspension for fungicidal treatment (in particular of wood preservatives) as well as a corresponding fungicidally treated wood preservative.

Coating materials have the object of protecting the substrate to be treated against various environmental influences, of making surroundings more attractive aesthetically as well as of taking necessary technical properties into account.

Particularly in the field of wood preservation, compounds such as 3-iodo-2-propynyl butyl carbamate or triazoles such as propiconazole or tebuconazole are known. Furthermore, inorganic compounds such as copper, silver or chromium salts are used.

Moreover, it has been known for decades that boric acid and borax (disodium tetraborate hydrate), individually and in mixtures in wood coatings, are effective against various kinds of fungi. However, because of their water solubility, these chemicals are classified as highly dangerous and hazardous to health. Particularly the high degree of water solubility and thus the extreme leaching behaviour of these boron compounds and emission into the environment are highly contentious and are regarded as critical. Water solubility leads to an obligation to label the formulations, with the result that the use thereof will probably be prohibited in the next few years, in accordance with REACH. Water-soluble borates are thus no longer common alternatives.

U.S. Pat. No. 5,224,315 describes a building material. The material is composed with a core comprising a number of layers of plastic foam material. The core contains 1 to 20 wt. % encapsulated borate compounds. An example borate compound is TIM-BOR® from the US Borax Corporation (disodium octaborate tetrahydrate). However, such encapsulation for limiting water solubility is expensive.

According to the abstract of CN 103589286 A, a priming paint is described therein, disclosing 2 to 3 parts by weight of zinc borate in an epoxy resin base. The priming paint also has an insulating effect.

In addition there are water-insoluble borates. These also include calcium borate, among others.

US 2002/0182431 A1 describes a process for producing wood composite treated with borate. In the patent specification, the fungicidal effect of borates is discussed, wherein calcium borate is described as advantageous because of its low solubility. In US 2002/0182431 no reference is made to a grain size as has proved essential according to the present invention.

According to WO 01/87559 A2, calcium borate is suitable as a pesticide for lignocellulose-based composite materials. It is described therein that the particle size of the calcium borate does not matter. In WO 01/87559 A2 an average particle size of from 1 to 500 μm is recommended, preferably 10 to 150 μm.

According to the abstract of JPS6426401 A, a means for the flame-retardant treatment of wood is described therein. For this, an inorganic compound is produced as fine powder in a hydrophobic organic solvent, and the wood is impregnated therewith. An example water-insoluble and flame-retardant inorganic compound is calcium borate, wherein the inorganic compound with a diameter of less than 0.1 μm is to be used. Alternative inorganic compounds are silicon dioxide, aluminium oxide, antimony oxide, calcium carbonate, calcium phosphate and barium phosphate. Fire protection is achieved, wherein the inorganic compounds tend to form glass at high temperatures.

The present invention is, in particular, based on the object of inhibiting the natural decay of substrates and coatings. An impregnating agent with a multifunctional property is to be provided for natural and artificially-produced porous substrates, such as wood, paper, concrete, natural stone or other substrates, which can absorb aqueous media. The essential properties comprise the following aspects:
1. Creation of a moisture barrier
2. UV protection
3. Flame-retardant effect
4. Growth-inhibiting effect on wood-destroying and wood-discolouring fungi, bacteria and animals
5. Inhibiting effect on surface-discolouring wood contents

This object is achieved according to the present invention by a cation borate present in powder form, with
a.a maximum water solubility of 5 g/l (at 20° C.), indicated as free boron, and
b.a d90 grain size, determined according to ISO 20998-1:2006, of less than 500 nm,
   wherein the powder contains bonding agents selected from the group of titanates, aluminates, zirconates, silanes and mixtures thereof.

According to the invention, the water solubility is preferably determined by means of conductometric titration, for example according to Kohlrausch, or by means of direct potentiometric titration.

Following inoculation with wood-destroying fungi, bacteria and animals, such as Aureobasidium pullulans, Sclerqphoma pithyopila and Aspergillus niger, it was shown that the powder according to the invention, as suspension, due to its very small grain size, is able to penetrate deep into the wood and shows a significantly broader uninfested area compared with commercial wood preservatives. Materials with an average particle size of 20 nm and greater are preferably to be found in the intercellular spaces (lumens). Smaller particles can even penetrate into the cells and cell walls and thus substantially improve effectiveness due to the increased concentration. The composition according to the invention, via a colloidally distributed insoluble borate in combination with bonding agents, combines good multifunctional properties described as non-hazardous or low-hazard, and indicated in safety data sheets.

Wood treated according to the invention is finished hydrophobically. It is thereby guaranteed that moisture cannot penetrate, however, good vapour diffusion remains guaranteed. This moisture barrier guarantees both the inhibiting effect against discolouring wood contents and a substrate medium inhibiting wood-destroying or -discolouring fungi, bacteria and animals. This counteracts wood shrinkage and the wood thus has reinforcing properties. Due to the chemically very inert properties, the substrate-damaging UV rays are inhibited in their activity.

According to the present invention, wood-destroying fungi and bacteria are inhibited in their growth or their development is prevented, while at the same time the agents are non-toxic to humans, pets and the environment. Under intense heat a glass film is formed, which can to a certain extent protect the substrate against flammability.

### DETAILED DESCRIPTION OF THE INVENTION

In a first aspect the invention relates to a cation borate present in powder form with a. a maximum water solubility of 5 g/l (at 20° C.), indicated as free boron, and b. a d90 grain size, determined according to ISO 20998-1:2006, of less than 500 nm, wherein the powder contains bonding agents selected from the group consisting of titanates, aluminates, zirconates, silanes and mixtures thereof.

Preferably, the d90 grain size of the cation borate present in powder form according to the invention is less than 450 nm and preferably less than 400 nm, in particular less than 350 nm, for example less than 300 nm, such as less than 250 nm, preferably less than 200 nm, in particular less than 200 nm, such as less than 150 nm or less than 100 nm, in each case determined according to ISO 20998-1:2006.

In addition it is preferable for the water solubility to be at least 0.1 g/l of water (at 20° C.), relative to free boron.

Preferably, the cation of the cation borate present in powder form according to the invention is selected from the group consisting of magnesium, calcium, strontium, barium, lithium, aluminium, titanium, silicon, zinc, manganese, zirconium, silicon, ammonium and mixtures thereof.

Preferably, the cation of the cation borate present in powder form according to the invention is one or more alkaline-earth borate(s), preferably calcium, barium or mixtures thereof. A powder is preferred, which overall comprises at least 51 wt.-% calcium borate and barium borate, more preferably at least 62 wt.-%, in particular at least 70 wt.-%, such as at least 75 wt.-%.

A preferred powder is characterized in that it comprises at least 50 wt.-% calcium borate, preferably at least 60 wt.-% calcium borate, more preferably at least 65 wt.-% calcium borate, in particular at least 70 wt.-% calcium borate, such as at least 75 wt.-% calcium borate, relative to the total weight of borate and indicated as Ca₃(BO₃)₂.

Preferred types of calcium borate are of synthetic or natural origin, wherein the calcium borate is preferably selected from colemanite (CaB₃O₄(OH)₃.3H₂O), jarandolite (CaB₃O₄(OH)₃) and hydroboracite (CaMgB₆O₈(OH)₆.3H₂O) and ulexite (Na_{0.3}Ca_{0.7}B₃O₄(OH)₃.H₂O).

In addition, powders are preferred which comprise 1 to 20 wt.-% barium borate, preferably 2 to 15 wt.-% barium borate, in particular 5 to 12 wt.-% barium borate, relative to the total weight of borate and indicated as Ba₃(BO₃)₂.

In addition, a powder is preferred which comprises 1 to 20 wt.-% zirconium borate, preferably 2 to 15 wt.-% zirconium borate, in particular 5 to 12 wt.-% zirconium borate, relative to the total weight of borate and indicated as Zr₃(BO₃)₄.

The cation borate present in powder form according to the invention contains bonding agent. The bonding agent is selected from the group of titanates, aluminates, zirconates, silanes and mixtures thereof, i.e. the powder contains one or more bonding agents selected from the group of titanates, aluminates, zirconates and silanes.

Preferably, the cation borate present in powder form is coated with the bonding agent.

During the production of the cation borate present in powder form according to the invention, the usual procedure is such that, for example, silane is added. If the (alternative or additional) bonding agent is titanate, aluminate or zirconate, then the bonding agent is typically introduced (and the cation borate powder preferably coated therewith), by using precursor compounds for titanate, aluminate or zirconate.

Example precursor compounds for bonding agents used according to the invention are:
titanium oxychloride (TiOCl₂),
titanium tetrachloride (TiCl₄),
lithium aluminate (LiAl(OH)₄),
zirconium oxychloride (ZrOCl₂),
2,2-(bis-2-propenolatomethyl)butanolato-tris(neodecanolato-O)-zirconium(IV),
2,2-(bis-2-propenolatomethyl)butanolato-tris((dodecyl)benzenesulfonato-O)-zirconium(IV),
2,2-(bis-2-propenolatomethyl)butanolato-tris((dioctyl)phosphato-O)-zirconium(IV) and
2,2-(bis-2-propenolatomethyl)butanolato-tris-(2-methyl-2-propenoato-O)-zirconium(IV).

In all the embodiments of the invention, it is preferable for silane to be used as bonding agent, wherein the silane is preferably an aminosilane.

A typical quantity of the one or more bonding agents (selected from the group consisting of titanates, aluminates, zirconates, silanes and mixtures thereof) in the cation borate present in powder form (powder according to the invention) is 0.05-30 percent by weight dry solids, preferably 0.5-12 percent by weight dry solids, relative to the weight of the cation borate to be used.

The production of the powders according to the invention takes place according to the state of the art by grinding, powder synthesis or by processes such as physical or chemical vapour deposition (PVD or CVD). Substances reducing the surface tension can be used, such as from the field of surfactants, oils, emulsifiers or fluoropolymers.

In addition to cation borate and bonding agents (selected from the group consisting of titanates, aluminates, zirconates, silanes and mixtures thereof), the powder according to the invention can thus contain further constituents, also further bonding agents.

In a second aspect, the invention relates to a process for producing the cation borate present in powder form according to the invention, in which:
a) cation borate is ground in the presence of the bonding agent and
b) the ground product is subjected to drying (preferably spray- or freeze-drying),
in order to obtain the cation borate in powder form.

In a third aspect, the invention relates to a suspension which comprises:
a. suspending agents and
b. the cation borate present in powder form according to the invention.

It is preferable for the suspension to comprise one or more solvents selected from water, glycols and hydrocarbons as suspending agents,

wherein the suspending agent preferably comprises one or more solvents selected from water, naphtha and ethylene glycol. The suspending agent of the suspension according to the invention is particularly preferably selected from water, ethylene glycol and mixtures thereof.

In a fourth aspect, the invention relates to the use of the cation borate present in powder form according to the invention or of the suspension according to the invention for the fungicidal, biocidal and insecticidal treatment of organic or inorganic binders, lacquer semi-finished products and coating materials,

preferably of lignose-containing synthetic or natural materials, glues, adhesives, plastics, polymer composites, carbon-based components, concrete, concrete replacement materials, tar and asphalt mixtures, inorganic or hybrid-based coating materials, textiles, glass, ceramic, glass ceramic, metals or metal melts or salt melts,
in particular for the fungicidal treatment of wood preservatives.

In a further embodiment of the fourth aspect, the invention relates to the use of the cation borate present in powder form according to the invention or of the suspension according to the invention for the light- and weather-resistant treatment of organic or inorganic binders, lacquer semi-finished products and coating materials,

preferably for the UV protection thereof,
in particular for the UV-protective treatment of wood preservatives.

In the use according to the invention, during the impregnation of wood, it is preferable for wood-discolouring contents (such as for example long-chain sugars, tannin or degradation products of lignin) to be completely or partially bound, and for penetration into the subsequent coatings to be prevented or temporally delayed.

It is preferable according to the invention for the quantity of cation borate to be 0.01 to 25 wt.-%, relative to the weight of the product treated, preferably 0.1 to 10 wt.-%.

In a further embodiment, the fourth aspect of the invention relates to the use of the cation borate present in powder form according to the invention or of the suspension according to the invention in a plant protection product, fertilizer, catalyst for changing the NOX in the air, CO absorber, neutron absorber, lubricant in oils, special glass or a flame retardant.

The suspension of the material produced can be processed as concentrate or as ready-for-use solution, to produce an impregnating solution for protecting wood and other substrates which absorb aqueous media. Application takes place by manual processes such as painting, immersion or spraying, or by industrial processes such as pressure impregnation.

The suspension can act as material-specific reinforcing agent and build up a barrier against moisture.

The concentrates or application solutions can, depending on the solvent base of the suspension, be coloured in pigment preparations that are water-soluble or soluble in aliphatic carbons. An addition of wax, silicone and/or acrylate dispersions for achieving a water-repellent effect or improving fixing is also possible.

The suspension can be incorporated as concentrate
into binder-containing water-based and into solvent-based systems (impregnations, primers, glazes) or
into water-based and into solvent-based glue preparations.

After compatibility testing, the suspension can be added, as wood preservative, to existing impregnations and glazes for wood and paper. The effective concentrations are 1-25 wt.-%, depending on the type of wood and paper and state of the wood. By “wood” is meant both solid wood and wood composites such as chipboard panels and plywood; here the wood preservative can optionally also be introduced in the glue mixing process.

During the use of organic binders or dispersion polymers, on the one hand commercial pure substances or hybrids from the field of acrylates, polyurethanes, polyvinyl acetates, epoxides, fluoropolymers, oils, casein, cellulose and glues as well as soy- and linseed-oil-based alkyd resins are used, and on the other hand substances from the field of inorganic binders, such as soluble glasses, cement, aluminates, burnt lime, anhydrite, ettringite, polyphosphates, phosphazenes, metal-oxide sols and salt mixtures are used. The quantity used can be between 0.1-85 wt.-%, but preferably in the range from 1-45 wt.-%.

The suspension can, as wood preservative, be mixed together with other commercial chemicals which are used as wood preservatives, in order to increase effectiveness, insofar as permitted by compatibility testing. These are for example:
3-iodo-2-propynyl butyl carbamate,
(+)-1-[2-(2,4-dichlorophenyl)-4-propyl-1,3-dioxolan-2-ylmethyl]-1H-1,2,4-triazole or
m-phenoxybenzyl 3-(2,2-dichlorovinyl)-2,2-dimethylcyclopropanecarboxylate.

The suspension can support the mixture of materials with respect to UV stability and counteract shrinking or swelling of lignocellulosic materials.

Further fillers and/or pigments of an organic and/or inorganic nature can be added to the suspension as desired.

In a fifth aspect, the invention relates to a wood preservative which comprises the powder present in powder form according to the invention or the suspension according to the invention, wherein the quantity of cation borate present in the wood preservative is 0.05 to 25 wt.-%, preferably 0.1 to 5 wt.-%, relative to the weight of the wood preservative.

Wood preservatives treated according to the invention can in addition contain commercial UV-protection agents. Preferred UV-protection agents are Tinuvin 292, Tinuvin 171, Tinuvin 5333 and Tinuvin 1130.

The wood preservative treated according to the invention preferably represents a moisture barrier and thus counteracts swelling. Furthermore, the wood preservative treated according to the invention preferably acts as a support particle in the pores of the wood and counteracts shrinking.

The advantages of the present invention result in particular from the following examples. Unless otherwise indicated, percentages relate to the weight.

### EXAMPLES

The production according to the invention of a powder according to the invention and a suspension according to the invention are described below.

Materials used:
Peptapon 52 (non-foaming suspension stabilizer, Zschimmer & Schwarz GmbH & Co. KG, Lahnstein, Germany),
Dolapix G65 (phosphonate preparation, Zschimmer Schwarz, Lahnstein, Germany),
Tego Dispers 651 (pigment-wetting and dispersing additive, Evonik Industries AG, Essen, Germany),
Texanol (ester alcohol, Eastman, Kingsport, Tenn., USA),
Tego Airex (defoamer and deaerator, Evonik Industries AG, Essen, Germany),
BYK-380 N (non-ionic acryl copolymer solution, BYK-Chemie GmbH, Wesel, Germany).

A mixture of 80 wt.-% natural calcium borate, 10 wt.-% barium borate and 10 wt.-% zirconium borate with a d90 value of approx. 75 μm, after drying at 110° C.+/−5° C., was transferred to a conventional tumbling mill, and ground therein for 8 h after the following were added (Table 1):

TABLE 1

| Components | Parts by weight |
|---|---|
| Borate | 100 |
| Water | 55 |
| Peptapon 52 | 0.2 |
| Dolapix G65 | 0.45 |

The slurry thus prepared was then further comminuted in two further steps. For this, the suspension was first ground with the process adjuvants listed below at 550 min⁻¹ for one hour in a planetary ball mill from Retsch (Table 2):

TABLE 2

| Components | Parts by weight |
|---|---|
| Tumbling mill grinding base | 100 |
| Water | 5 |
| Tego Dispers 651 | 1.5 |
| Texanol | 0.1 |
| Tego Airex 920 W | 0.1 |

This preparation step reduced the average grain size to below 1 μm. Further grinding took place after cooling the prepared glaze suspension (Table 3).

TABLE 3

| Components | Parts by weight |
|---|---|
| Planetary mill grinding base 1 h | 100 |
| Water | 4 |
| Byk 380 N | 0.7 |
| Texanol | 0.05 |

In this final grinding step, samples were taken at 5-min intervals. After approx. 45 min there was scarcely any further change in the grain size. The third step thus lasts 45 min at 650 min⁻¹ in the named planetary mill.

The powder according to the invention was then subjected to spray-drying and subsequently had a grain size of approx. 250 nm (d90).

A suspension according to the invention was then produced as follows from this powder in a further process step.

100 g of the powder with an average particle size of 250 nm was suspended in 100 g of water, while adding 0.05 wt.-% triethylamine and stirred at 45° C. for 3 hours. 15 g of zirconium oxychloride was then added while slowly stirring. Then 12 g of methyltriethoxysilane was added, which subsequently acts as a coupling medium. The pH should lie in the range from 5 to 6.5. Then 50 g of an acrylic acid resin and 20 g of a 30 wt.-% lithium aluminate solution were then added to this mixture, which had been produced over 16 h at 55° C. while constantly stirring. The adjusted pH was approximately 8.8.

The effectiveness of this suspension as fungicidal wood preservative was determined by means of an in-vitro process. For this, the suspension in small recesses was transferred dropwise onto a 2 wt.-% malt extract agar in petri dishes and inoculated with the wood-destroying fungi Aureobasidium pullulans, Sclerqphoma pithyopila, Aspergillus niger and Trichoderma viride (green wood mould). The dishes were then incubated at 22 to 24° C. for 3 days. After this period, the fungi in the control dishes have developed very well.

The fungicidal effectiveness of the suspension was assessed on the basis of the fungi-free areas resulting around the recesses (zones of inhibition) as follows (Table 4):

TABLE 4

| | | |
|---|---|---|
| No zone of inhibition | (−) | (no fungicidal effectiveness) |
| Small zone of | (+) | 2 mm (low fungicidal |
| inhibition | | effectiveness) |
| Average zone of | (++) | 2 to 6 mm (good fungicidal |
| inhibition | | effectiveness) |
| Large zone of | (+++) | 6 mm (very good fungicidal |
| inhibition | | effectiveness) |

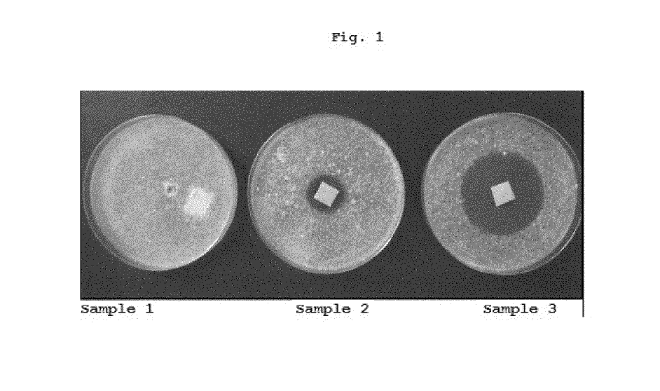

FIG. 1 shows, as an example, the fungicidal effectiveness on Aspergillus niger for the suspension according to the invention (Sample 3), in comparison with commercial fungicides (Sample 1 and Sample 2).

Thus the solution produced acts as impregnation/primer for wood in the area of the preventive wood protection. After weathering of a pinewood impregnated in this way in an accelerated weathering tester (QUV from QLab) it was possible to ascertain that the mass reduction of the wood only corresponded to 15 wt.-%, in comparison with wood treated with commercial impregnating primers. An irreversible shrinkage of the piece of wood due to sustained exposure to heat was only 5% instead of 12-20 wt.-% according to experience.

Furthermore, it was examined what influence the grain size of calcium borate has on the effectiveness of a suspension produced therefrom. The effectiveness of various suspensions is indicated in Table 5 below.

TABLE 5
Influence of the grain size of the borate on the
infestation of beechwood by mildew

| | First indication of a |
|---|---|
| | mildew infestation when |
| | stored at 30° C. after days |
| Treatment of the surface (S) | (d) |
| No treatment of the S | 4 |
| 3% suspension of calcium | 12 |
| borate (d90 <63 μm) | |
| 3% suspension of calcium | >150 |
| borate (d90 <0.6 μm) | |
| 3% suspension of calcium | >200 |
| borate (d90 <0.2 μm) | |

These results show that—in contrast to the teaching of WO 01/87559 A2—the particle size of the borate matters and a small particle size according to the invention (d90) of less than 500 nm is advantageous.

1. Cation borate present in powder form with
a. a maximum water solubility of 5 g/l (at 20° C.), indicated as free boron, and
b. a d90 grain size, determined according to ISO 20998-1:2006, of less than 500 nm,
wherein the powder contains bonding agents selected from the group of titanates, aluminates, zirconates, silanes and mixtures thereof.

2. Powder according to claim 1, wherein the d90 grain size is less than 450 nm, preferably less than 400 nm, in particular less than 350 nm, for example less than 300 nm, such as less than 250 nm, preferably less than 200 nm, in particular less than 200 nm, such as less than 150 nm or less than 100 nm, in each case determined according to ISO 20998-1:2006.

3. Powder according to claim 1, wherein the water solubility is at least 0.1 g/l of water.

4. Powder according to claim 1, wherein the cation is selected from the group consisting of magnesium, calcium, strontium, barium, lithium, aluminium, titanium, silicon, zinc, manganese, zirconium, silicon, ammonium and mixtures thereof.

5. Powder according to claim 1, wherein it comprises at least 50 wt.-% calcium borate, preferably at least 60 wt.-% calcium borate, more preferably at least 65 wt.-% calcium borate, in particular at least 70 wt.-% calcium borate, such as at least 75 wt.-% calcium borate, in each case relative to the total weight of cation borate and indicated as Ca₃(BO₃)₂.

6. Powder according to claim 4, wherein the calcium borate is of synthetic or natural origin,
wherein the calcium borate is preferably selected from colemanite (CaB₃O₄(OH)₃.3H₂O), jarandolite (CaB₃O₄(OH)₃) and hydroboracite (CaMgB₆O₈(OH)₆.3H₂O) and ulexite (Na_{0.3}Ca_{0.7}B₃O₄(OH)₃.H₂O).

7. Powder according to claim 4, wherein it comprises 1 to 20 wt.-% barium borate, preferably 2 to 15 wt.-% barium borate, in each case relative to the total weight of metal borate and indicated as Ba₃(BO₃)₂.

8. Powder according to claim 4, wherein it comprises 1 to 20 wt.-% zirconium borate, preferably 2 to 15 wt.-% zirconium borate, in each case relative to the total weight of cation borate and indicated as Zr₃(BO₃)₄.

9. Powder according to claim 1, wherein the powder is coated with the bonding agent.

10. Powder according to claim 1, wherein the silane is an aminosilane.

11. Process for producing the cation borate present in powder form according to claim 1, in which:
a) cation borate is ground in the presence of the bonding agent and
b) the ground product is subjected to drying (preferably spray- or freeze-drying),
in order to obtain the cation borate in powder form.

12. Suspension which comprises:
a. suspending agents and
b. the cation borate present in powder form according to claim 1.

13. Suspension according to claim 12, wherein the suspending agent comprises one or more solvents selected from water, glycols and hydrocarbons,
wherein the suspending agent preferably comprises one or more solvents selected from water, naphtha and ethylene glycol.

14. Use of the powder according to claim 1, for the fungicidal, biocidal and insecticidal treatment of organic or inorganic binders, lacquer semi-finished products and coating materials,
preferably of lignose-containing synthetic or natural materials, glues, adhesives, plastics, polymer composites, carbon-based components, concrete, concrete replacement materials, tar and asphalt mixtures, inorganic or hybrid-based coating materials, textiles, glass, ceramic, glass ceramic, metals or metal melts or salt melts,
in particular for the fungicidal treatment of wood preservatives.

15. Use of the powder according to claim 1, for the light- and weather-resistant treatment of organic or inorganic binders, lacquer semi-finished products and coating materials,
preferably for the UV protection thereof,
in particular for the UV-protective treatment of wood preservatives.

16. Use according to claim 14, wherein during the impregnation of wood, wood-discolouring contents (such as for example long-chain sugars, tannin or degradation products of lignin) are completely or partially bound, and penetration into the subsequent coatings is prevented or temporally delayed.

17. Use according to claim 14, wherein the quantity of cation borate is 0.01 to 25 wt.-%, relative to the weight of the product treated, preferably 0.1 to 10 wt.-%.

18. Use of the powder according to claim 1, wherein in a plant protection product, fertilizer, catalyst for changing the NOX in the air, CO absorber, neutron absorber, lubricant in oils, special glass or a flame retardant.

19. Wood preservative which comprises the powder according to claim 1, wherein the quantity of cation borate present in the wood preservative is 0.05 to 25 wt.-%, preferably 0.1 to 5 wt.-%, relative to the weight of the wood preservative.
